(19) United States
(12) Patent Application Publication
(10) Pub. No.: US 2007/0085767 A1
(43) Pub. Date: Apr. 19, 2007

(54) Plasma display and driving method thereof

(76) Inventors: Nam-Sung Jung, Suwon-si (KR); Jung-Pil Park, Suwon-si (KR); Du-Yeon Han, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/583,401

(22) Filed: Oct. 18, 2006

(30) Foreign Application Priority Data
Oct. 18, 2005 (KR) 10-2005-0098026

(51) Int. Cl. G09G 3/28

(52) U.S. Cl. 345/63

(57) ABSTRACT

A plasma display device is driven by dividing a plurality of row electrodes into first and second row groups. A first row group of electrodes are dividedinto a plurality of first sub-groups, and a second row group of row electrodes are divided into a plurality of second sub-groups. During a first subfield of a first group of subfields, non-light emitting cells are selected from light emitting cells of a first sub-groups and light emitting cells of a second sub-groups are sustain-discharged during a first period. In addition, during the first subfield, the non-light emitting cells are selected from the second sub-group, and the light emitting cells of a first sub-group are sustain-discharged during a second period. With such an operation, a length of one subfield can be reduced because another row group is sustain-discharged while one row group is being selected as the non-emitting cells.

### CROSS-REFERENCE TO RELATED APPLICATION

This application claims priority to and the benefit of Korean Patent Application No. 10-2005-0098026 filed in the Korean Intellectual Property Office on Oct. 18, 2005, the entire content of which is incorporated herein by reference.

### BACKGROUND OF THE INVENTION

1. Field of the Invention

The present invention relates to a plasma display device and a driving method thereof.

2. Description of the Related Technology

A plasma display device is a flat panel display that uses plasma generated by a gas discharge process to display characters or images. It includes a plurality of discharge cells arranged in a matrix pattern.

On a panel of the plasma display device, a field (e.g., 1 TV field) is divided into a plurality of subfields respectively having a weight. Gray scales are expressed by a combination of weights of subfields at which a display operation is generated from among the subfields. Each subfield has an address period in which an address operation for selecting discharge cells to emit light and discharge cells to emit no light from among a plurality of discharge cells, and a sustain period in which a sustain discharge occurs in the selected discharge cells to perform a display operation during a period corresponding to a weight of a subfield.

Such a plasma display device uses subfields having a different weight value for expression of grayscales. In addition, a grayscale of the corresponding discharge cell is expressed by a total of the weight values of subfields which the discharge cell emits light among the plurality of subfields. For example, when the subfields with weights in the format of a power of 2 are used, a false contour (dynamic false contour) can occur when a discharge cell expresses the grayscales of 127 and 128 in two consecutive fields.

In addition, when address and sustain periods are separated with a predetermined interval, a length of one subfield become longer because the respective subfields have additionally formed address periods for addressing all the discharge cells other than the sustain period for a sustain discharge. As a result, the number of subfields available in one field is reduced since the subfield has a longer length.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The present invention has been made in an effort to provide a plasma display device and a driving method thereof having advantages of reducing false contour and an unfavorable length of a subfield.

One embodiment is a method of driving a plasma display device, the plasma display device having a plurality of row electrodes, a plurality of column electrodes, and a plurality of discharge cells. The method includes dividing a frame into subfields, dividing the plurality of row electrodes into first and second row groups, dividing the first row group into a plurality of first sub-groups, dividing the second row group into a plurality of second sub-groups, selecting one or more discharge cells from a first sub-group to be non-light emitting during a first period of a first subfield, where the remaining discharge cells of the first sub-group remain light emitting, sustain-discharging one or more light emitting cells of a second sub-group during the first period, selecting one or more discharge cells from a second sub-group to be non-light emitting during a second period of a first subfield, where the remaining discharge cells of the second sub-group remain light emitting, and sustain-discharging one or more light emitting cells of a first sub-group during the second period.

Another embodiment is a plasma display device including a plasma display panel (PDP) including a plurality of row electrodes configured to perform a display operation and a plurality of column electrodes formed in a direction crossing the row electrodes, and a plurality of cells formed near crossing points of the plurality of row electrodes and the plurality of column electrodes. The PDP also includes a controller configured to divide a field into a plurality of subfields, divide the plurality of row electrodes into first and second row groups, divide the first row group of row electrodes into a plurality of first sub-groups, and divide the second row group of row electrodes into a plurality of second sub-groups. Th PDP also includes a driver configured to drive the plurality of row electrodes and the plurality of column electrodes, where the driver is configured to select one or more discharge cells from a first sub-group to be non-light emitting during a first period of a first subfield, where the remaining discharge cells of the first sub-group remain light emitting, sustain-discharge one or more light emitting cells of a second sub-group during the first period, select one or more discharge cells from a second sub-group to be non-light emitting during a second period of a first subfield, where the remaining discharge cells of the second sub-group remain light emitting, and sustain-discharge one or more light emitting cells of a first sub-group during the second period.

Another embodiment is a method of driving a plasma display device, the plasma display device having a plurality of row electrodes, a plurality of column electrodes, and a plurality of discharge cells. The method includes dividing a frame into a plurality of subfields, dividing the plurality of row electrodes into first and second row groups, dividing the first row group into a plurality of first sub-groups and dividing the second row group into a plurality of second sub-groups, during a first subfield, selecting light emitting cells from the first row group and sustain discharging the selected light emitting cells of the first row group, during the first subfield, selecting light emitting cells from the second row group and sustain-discharging the selected light emitting cells of the second row group, selecting non-light emitting cells from a first sub-group and sustain-discharging light emitting cells of a second sub-group during a first period of a second subfield, and selecting non-light emitting cells from a second sub-group and sustain-discharging the light emitting cells of a first sub-group during a second period during the second subfield.

### BRIEF DESCRIPTION OF THE DRAWINGS

FIG. 1 shows a schematic diagram for a plasma display device according to an embodiment.

FIG. 2 shows a method for grouping the respective electrodes used in a driving method of a plasma display device according to an embodiment.

FIG. 3 shows a driving method of a plasma display device according to an embodiment.

FIG. 4 shows a driving method of FIG. 3 using only a subfield.

FIG. 5 shows a driving waveform of a plasma display device according to a driving method of FIG. 3.

FIG. 6 shows a method for expressing a grayscale using a driving method of FIG. 3 according to an embodiment.

FIG. 7 shows a method for expressing a grayscale using a driving method of FIG. 3 according to another embodiment.

FIG. 8A and FIG. 8B respectively shows a method for realizing a weight value of subfields SF1 to SF6.

FIG. 9 schematically shows a driving method of a plasma display device according to an embodiment.

FIG. 10 schematically shows a driving method of a plasma display device according to still another embodiment.

### DETAILED DESCRIPTION OF CERTAIN INVENTIVE EMBODIMENTS

In the following detailed description, only certain embodiments have been shown and described, simply by way of illustration. As those skilled in the art would realize, the described embodiments may be modified in various ways, without departing from the spirit or scope of the present invention. To clarify the description, certain parts that are not described in the specification are omitted, and certain parts for which similar descriptions are provided have the same reference numerals

In addition, throughout this specification and the claims which follow, unless explicitly described to the contrary, the word “comprise” or variations such as “comprises” or “comprising” will be understood to imply the inclusion of stated elements but not the exclusion of any other elements.

In addition, wall charges mentioned in the following description mean charges formed and accumulated on a wall (e.g., a dielectric layer) close to an electrode of a discharge cell. A wall charge will be described as being “formed” or “accumulated” on the electrode, although the wall charges generally do not actually touch the electrodes. Further, “a wall voltage” means a potential formed on the wall of the discharge cell by the wall charge.

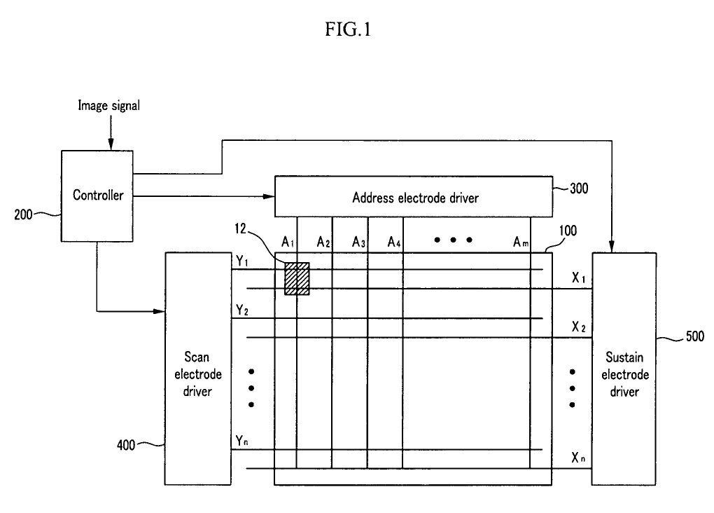

A plasma display device according to an embodiment will now be described with reference to FIG. 1.

FIG. 1 shows a diagram representing a plasma display device according to the embodiment.

As shown in FIG. 1, the plasma display device includes a plasma display panel (PDP) 100, a controller 200, an address electrode driver 300, a scan electrode driver 400, and a sustain electrode driver 500.

The PDP 100 includes a plurality of address electrodes A₁ to Aₘ (hereinafter referred to as “A electrodes”) extending in a column direction, and a plurality of sustain and scan electrodes X₁ to Xₙ and Y₁ to Yₙ (hereinafter respectively referred to as “X electrodes” and “Y electrodes”) extending in a row direction in pairs. The X electrodes X₁ to Xₙ are formed in correspondence to the Y electrodes Y₁ to Yₙ, and a display operation is performed by the X and Y electrodes in the sustain period. The Y and X electrodes Y₁ to Yₙ and X₁ to Xₙ are arranged perpendicular to the A electrodes A₁ to Aₘ. Here, a discharge space formed at an area where the A electrodes A₁ to Aₘ cross the X and Y electrodes X₁ to Xₙ and Y₁ to Yₙ forms a discharge cell 12. The configuration of the PDP 100 shown in FIG. 1 is an example, and other configurations may be applied. Hereinafter, the X and Y electrodes extending in pairs in a row direction are referred to as a row electrodes, and the A electrodes extending in a column direction are referred to as column electrodes.

The controller 200 outputs X, Y, and A electrode driving control signals after receiving an image signal. In addition, the controller 200 drives the plasma display device by dividing a frame into a plurality of subfields and controls the plasma display device by dividing the plurality of row electrodes into first and second row groups and by dividing the first and second row groups into a plurality of respective sub-groups.

The address electrode driver 300 receives the address electrode driving control signal from the controller 200, and applies a display data signal for selecting a discharge cell to be discharged to each address electrode A.

The scan electrode driver 400 receives the scan electrode driving control signal from the controller 200, and applies the driving voltage to the scan electrode Y.

The sustain electrode driver 500 receives the sustain electrode driving control signal from the controller 200, and applies the driving voltage to the sustain electrode X.

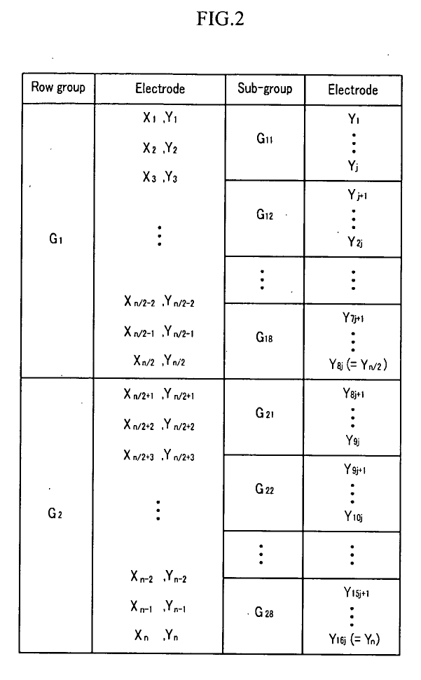

Referring to FIG. 2, a driving method of the plasma display device according to an embodiment will now be described in more detail.

FIG. 2 shows a method for grouping the respective electrodes used in a driving method of a plasma display device.

As shown in FIG. 2, at one field the plurality of row electrodes X₁ to Xₙ and Y₁ to Yₙ are divided into two row groups, that is, first and second row groups G₁ and G₂. Here, the first row group G₁ may include a plurality of X electrodes X₁ to X_{n/2} and a plurality of Y electrodes Y₁ to Y_{n/2} placed in an upper area of the PDP 100, and the second row group G₂ may include a plurality of X electrodes X_{(n/2)+1} to Xₙ and a plurality of Y electrodes Y_{(n/2)+1} to Yₙ placed in a lower area of the PDP 100, and the first row group G₁ may include even-numbered row electrodes and the second row group G₂may include odd-numbered row electrodes. In addition, the plurality of Y electrodes of the first and second row groups G₁ and G₂ respectively are again divided into the plurality of sub-groups G₁₁ to G₁₈ and G₂₁ to G₂₈. In FIG. 2, it is assumed that the first and second row groups G₁ and G₂ are respectively divided into eight sub-groups G₁₁ to G₁₈ and G₂₁ to G₂₈.

That is, in the first row group G₁, first to j-th Y electrodes Y₁ to Yⱼ are grouped into a first sub-group G₁₁, and (j+1)-th to 2j-th Y electrodes Yⱼ₊₁ to Y₂ⱼ are grouped into a second sub-group G₁₂. In such a manner, (7j+1)-th to (n/2)-th Y electrodes Y₇ⱼ₊₁ to Y_{n/2} are grouped into an eighth sub-group G₈ (here, j is given as a integer between 1 and n/16). Likewise, in the second row group G₁, (8j+1)-th to 9j-th Y electrodes Y₈ⱼ₊₁ to Y₉ⱼ are grouped into a first sub-group G₂₁, and (9j+1)-th to 10j-th Y electrodes Y₉ⱼ₊₁ to Y₁₀ⱼ are grouped into a second sub-group G₂₂. In such a manner, (15j+1)-th to n-th Y electrodes Y₁₅ⱼ₊₁ to Yₙ are grouped into an eighth sub-group G₂₈. Meanwhile, the Y electrodes spaced with a predetermined interval in the first and second row groups G₁ and G₂ may be grouped into one sub-group, and the Y electrodes may be grouped in an irregular manner.

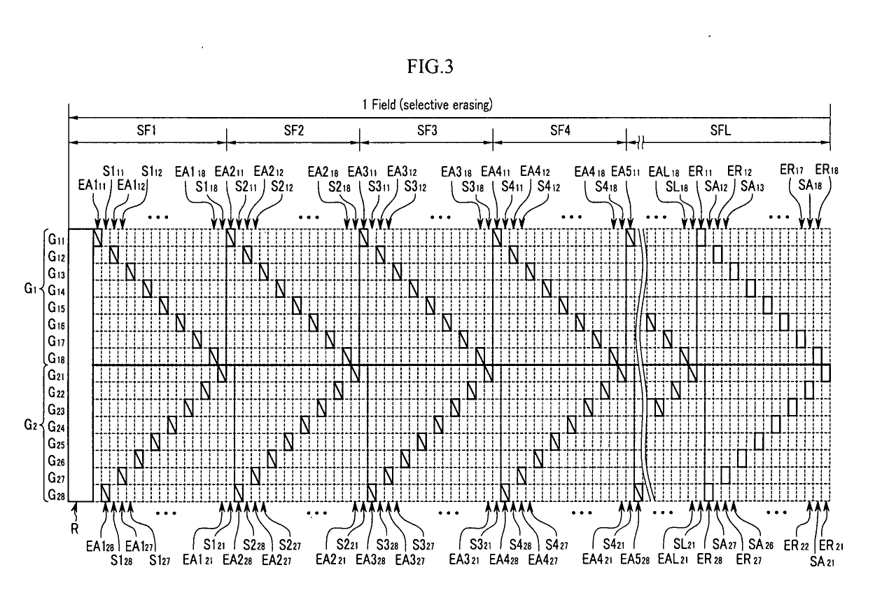

FIG. 3 shows a driving method of a plasma display device according to an embodiment. According to the embodiment, the address and sustain periods have the same length, and the sustain period has the same length over all the subfields.

Referring to FIG. 3, one field includes a plurality of subfields SF1 to SFL. First to L-th subfields SF1 to SFL respectively include address periods EA1₁₁ to EAL₁₈ and EA1₂₁ to EAL₂₈, and sustain periods S1₁₁ to SL₁₈ and S1₂₁ to SL₂₈, and a selective erase method is used in the address periods EA1₁ to EAL₈ of the first to L-th subfields SF1 to SFL. In addition, as described in FIG. 2, the plurality of row electrodes X₁ to Xₙ and Y₁ to Yₙ are divided into the two first and second row groups G₁ and G₂, and the first and second row groups G₁ and G₂ are respectively divided into the plurality of sub-groups G₁₁ to G₁₈ and G₂₁ to G₂₈.

There are selective write methods and selective erase methods which can be used to select discharge cells to emit light and discharge cells to emit no light among the plurality of discharge cells. The selective write methods select discharge cells to emit light and form a constant wall voltage. The selective erase methods select discharge cells to emit no light and erases the formed wall voltage. That is, a selective write method sets a discharge cell to become a light-emitting cell state by address-discharging the same so as to form wall charges therein, and a selective erase method sets the light-emitting discharge cell to be in a non-light emitting cell state by address-discharging the same so as to erase the wall voltage formed therein. According to these methods, an address discharge for forming the wall voltage will be referred to as a “write discharge” and an address discharge for erasing the wall charge will be referred to as an “erase discharge”.

Referring to FIG. 3, a reset period R is provided immediately before the address period EA1₁ of the first subfield SF1 provided foremost among the first to L-th subfields SF1 to SFL having the address periods EA1₁₁ to EAL₁₈ and EA1₂₁ to EAL₂₈of the selective erase method, such that all the discharge cells are initialized and set as the light emitting cell state by the reset period R. That is, all the discharge cells are initialized and set as the light emitting cell state during the reset period R, and are set as a cell state that is capable of performing an erase discharge during the address period EAL.

Then, at the first subfield SF1, the address periods EA1₁₁ to EAL₁₈ and EA1₂₁ to EAL₂₈ and sustain periods S1₁₁ to SL₁₈ and S1₂₁ to SL₂₈ are sequentially performed for the respective first to eighth sub-groups G₁₁ to G₁₈ and G₂₁ to G₂₈ of the first and second row group G₁ and G₂. At the respective subfields SF1 to SFL of the first row group G₁, the address periods EA1₁₁ to EAL₁₈ and sustain periods S1₁₁ to SL₁₈ are performed from the first sub-group G₁₁ to the eighth sub-group G₁₈, and at the respective subfields SF1 to SFL of the second row group G₂, the address periods EA1₂₈ to EAL₂₁ and sustain periods S1₂₈ to SL₂₁ are performed from the eighth sub-group G₂₈ to the first sub-group G₂₁. That is, at the k-th subfield SFk of the first row group G₁, address periods EAk₁ᵢ of the i-th sub-group G₁ᵢ are performed and then sustain periods Sk₁ᵢ of the i-th sub-group G₁ᵢ are performed (here, k is an integer in a range of 1 to L and i is an integer in a range of 1 to 8). Subsequently, address periods EAk₍ᵢ₊₁₎ and sustain periods Sk₁₍ᵢ₊₁₎ of (i+1)-th sub-group G₁₍ᵢ₊₁₎ are performed. At the k-th subfield SFk of the second row group G₂, address periods EAk₂₍ᵢ₊₁₎ of the (i+1)-th sub-group G₂₍ᵢ₊₁₎ are performed and then sustain periods Sk₂₍ᵢ₊₁₎ of the (i+1)-th sub-group G₂₍ᵢ₊₁₎) are performed. Subsequently, address periods EAk₂ᵢ and sustain periods Sk₂ᵢ of the i-th sub-group G₂ᵢ are performed. In addition, at the k-th subfield SFk, the address periods EAk₂₍₈₋₍ᵢ₋₁₎₎ of the (8−(i−1))-th sub-group G₂₍₈₋₍ᵢ₋₁₎₎ of the second row group G₂ are performed while the sustain periods Sk₁ᵢ of the i-th sub-group G₁ᵢ of the first row group G₁ are performed. At the k-th subfield SFk, the address periods EAk₁₍ᵢ₊₁₎ of the (i+1)-th sub-group G₁₍ᵢ₊₁₎ of the first row group G₁ are performed while the sustain periods Sk₂₍₈₋₍ᵢ₋₁₎₎ of the (8−(i−1))-th sub-group G₂₍₈₋₍ᵢ₋₁₎₎ of the second row group G₂ are performed.

However, as shown in FIG. 3, at the (k+1)-th subfield SF(k+1), address periods EA(k+1)₁₁ of the first sub-group G₁₁ of the first row group G₁ are performed while at the k-th subfield SFk, the sustain periods Sk₂₁ of the first sub-group G₁₁ of the second row group G₂ are performed.

In FIG. 3, at the second row group G₂, the address periods EAk₂₈ to EAk₂₁ and sustain periods S₂₈ to S₂₁ are performed from the eighth sub-group G₂₈ to the first sub-group G₂₁. However, unlike FIG. 3, at the second row group G₂, the address periods EAk₂₁ to EAk₂₈ and sustain periods S1₂₁ to SL₂₈ may be performed from the first sub-group G₂₁ to the eighth sub-group G₂₈, in the same manner as in the first row group G₁. In addition, in the first and the second row groups G₁ and G₂, the address and sustain periods may be performed in a different sequence from that shown in FIG. 3.

Next, the respective subfields SF1 to SFL of the first row group G₁ will be described in detail. Since the address and sustain periods have substantially the same operations for each of the respective subfields SF1 to SFL, the operation for only the k-th subfield SFk will be described (here, k is given as an integer in the range of 1 to L).

In the k-th subfield SFk of the first row group G₁, during the address period EAk₁₁ of the first sub-group G₁₁, the erase discharges are generated in the discharge cells to be set as the non-light emitting cells among the light emitting cells of the first sub-group G₁₁, and accordingly the wall charges are erased. During the sustain period Sk₁₁, the other light-emitting cells of the first sub-group G₁₁ are sustain-discharged. Then, during the address period EAk₁₂ of the second sub-group G₂₁, the erase discharges are generated in the discharge cells to be set as the non-light emitting cells among the light emitting cells of the second sub-group G₁₂, and accordingly the wall charges are erased. During the sustain period Sk₁₂, the other light emitting cells of the second sub-group G₁₂ are sustain-discharged. In addition, the light emitting cells of the first sub-group G₁₁ are sustain-discharged.

In such a manner, the address period EAk₁₃ to EAk₁₈ and sustain period Sk₁₃ to Sk₁₈ are performed in other sub-groups G₁₃ to G₁₈. During the sustain periods Sk₁ᵢ of the i-th sub-group G₁ᵢ, the light emitting cells of the i-th sub-group G₁ᵢ, the first to (i−1)-th sub-groups G₁₁ to G₁₍ᵢ₋₁₎, and the (i+1)-th to eighth sub-group G₁₍ᵢ₊₁₎ to G₁₈are sustain-discharged. The light emitting cells of the first to (i−1)-th sub-groups G₁₁ to G₁₍ᵢ₋₁₎ have not undergone an erase discharge during the respective address periods EAk₁₁ to EAk₁₍ᵢ₋₁₎ of the k-th subfield SFk, and the light emitting cells of the (i+1)-th to eighth sub-groups G₁₍ᵢ₊₁₎ to G₁₈ have not undergone an erase discharge during the respective address period EA(k−1)₁₍ᵢ₊₁₎ to EA(k−1)₁₈ of the (k−1)-th subfield SF(k−1). In addition, the light emitting cells of the i-th sub-group G₁ᵢ have undergone a sustain discharge until the sustain period SK₁₍ᵢ₋₁₎ that is before the address period EA(k+1)₁ᵢ of the i-th sub-group G₁ᵢ of the (k+1)-th subfield (SF(k+1)). That is, the light emitting cells of the i-th sub-group G₁ᵢ are sustain-discharged during the total of eight sustain periods.

As such, at all the subfields SF1 to SFL, the address periods EA2₁₁ to EA2₁₈, . . . , and EAL₁₁ to EAL₁₈ and sustain periods S2₁₁ to S2₁₈, . . . , SL₁₁, to SL₁₈ are performed for the respective sub-groups G₁₁ to G₁₈. With the discharge cells operated in such a manner, the discharge cells that are set as the light emitting cells perform a sustain discharge during the reset period R until the discharge cells are set as the non-light emitting cells by the erase discharges at the respective subfields SF1 to SFL. When the discharge cells become non-light emitting cells by the erase discharges, the discharge cells are not sustain-discharged after the corresponding subfields. Accordingly, the respective subfields SF1 to SFL have weight values corresponding to a sum of the lengths of the eight sustain periods of the respective subfields SF1 to SFL.

When the sustain period SL₁₈ of the eighth sub-group G₁₈ is applied to the subfield SFL, the sustain discharge has been performed eight times in the first sub-group G₁₁, seven times in the second sub-group G₁₂, six times in the third sub-group G₁₃, five times in the fourth sub-group G₁₄, and four times in the fifth sub-groups G₁₅. Further, the sustain discharge is performed by three times in the sixth sub-group G₁₆, twice in the seventh sub-group G₁₇, and once in the eighth sub-group G₁₈.

Accordingly, the first to eighth sub-groups G₁₁ to G₁₈ may have the same number of sustain discharges. For this purpose, the last subfield SFL of the first row group G₁ may have erase periods ER₁₁ to ER₁₇ and additional sustain periods SA₁₂ to SA₁₈.

In more detail, the first sub-group G₁₁ where the sustain discharge is performed by eight times before subsequent erase periods may not need to experience an. additional sustain discharge. Therefore, wall charges formed in the light emitting cells of the first sub-group G₁₁ are erased during the erase period ER₁₁. Then, the light emitting cells of the first to eighth sub-groups G₁₁ to G₁₈ emit light during the additional sustain discharge period SA₁₂. At this time, since the wall charges formed in the light emitting cells of the first sub-group G₁₁ were erased during the erase period ER₁₁, the additional sustain discharge is performed by once in the light emitting cells of the second to eighth sub-groups G₁₂ to G₁₈ during the additional sustain discharge period SA₁₂.

In addition, since the second sub-group G₁₂ where the sustain discharge is performed by eight times due to the addition sustain period SA₁₂ may not need to experience an additional sustain discharge, wall charges formed in the light emitting cells of the second sub-group G₁₂ are erased during the erase period ER₁₃. Then, the light emitting cells of the first to eight sub-groups G₁₁ to G₁₈ emit light during the addition sustain period SA₁₃. At this time, since the wall charges formed in the light emitting cells of the first and second sub-groups G₁₁ and G₁₂ were erased during the respective erase periods ER₁₁ and ER₁₂, the additional sustain discharge is performed by once in the light emitting cells of the third to eighth sub-groups G₁₃ to G₁₈ during the addition sustain period SA₁₃.

In addition, wall charges formed in the light emitting cells of the third sub-group G₁₃ are erased during the erase period ER₁₃ since the third sb-group G₁₃ where the sustain discharge is performed by eight times in third sub-group G₁₃ due to the addition sustain period SA₁₃ may not need to experience an addition sustain discharge. Then, the light emitting cells of the first to eighth sub-groups G₁₁ to G₁₈ emit light during the addition sustain period SA₁₄. At this time, since the wall charges formed in the first to third sub-groups G₁₁ to G₁₃ were erased during the respective erase periods ER₁₁ to ER₁₃, the addition sustain discharge is performed once in the light emitting cells of the fourth to eighth sub-groups G₁₄ to G₁₈ respectively during the addition sustain period SA₁₄.

An erase period ER₁₈ may be provided after the additional period SA₁₈ of the eighth sub-group G₁₈ so as to erase wall charges of the eighth sub-group G₁₈. Also, since the reset period R is applied to a first subfield SF1 of a consecutive field, the erase period ER₁₈ of the eighth sub-group G₁₈ may not be formed. The erase operation may also be sequentially applied to each row electrode of the respective sub-groups during the erase periods ER₁₁ to ER₁₈ similar to the address operation, or may be simultaneously applied to the entire row electrodes of the respective row groups.

Subfields SF1 to SFL of the second row group G₂ will now be described. A structure of each subfield SF1 to SFL of the second row group is substantially equivalent to that of each subfield SF1 to SFL of the first row group G₁. However, as previously described, the address periods EA1₂₈-EA1₂₁, . . . , EAL₂₈-EAL₂₁ are applied from the eighth sub-group G₂₈ to the first sub-group G₂₁ in the respective subfields SF1 to SFL of the second row group G₂, and the erase periods ER₂₁ to ER₂₈ are also applied from the eighth sub-group G₂₈ to the first sub-group G₂₁ in the last subfield SFL of the second row group G₂.

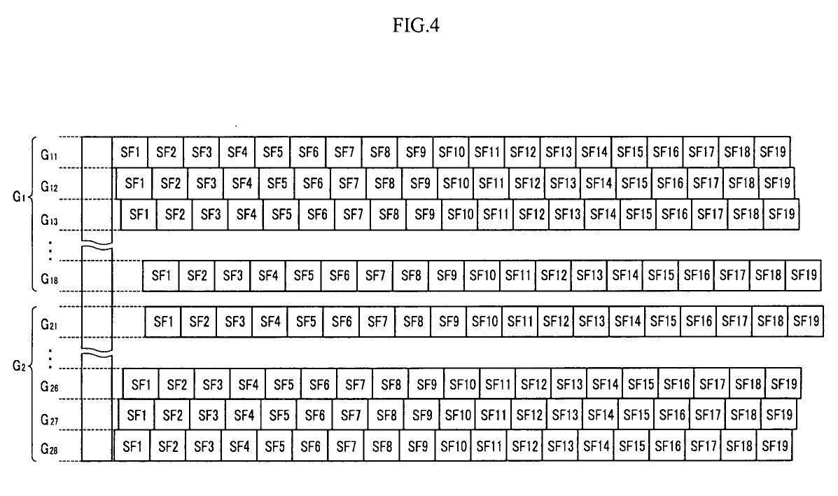

Such a driving method of the plasma display device can be described with subfields as shown in FIG. 4. In FIG. 4, one field is formed of 19 subfields SF1 to SF19. It is illustrated in FIG. 4 that sub-groups G₁₁ to G₁₈ and G₂₈ to G₂₁ respectively have a plurality of subfields SF1 to SF19 that form one field and that the plurality of subfields are shifted by a time from each other. The amount of shift in the time corresponds to a sum of an address period EAk₁ᵢ or EAk₂ᵢ of one sub-group G₁ᵢ or G₂ᵢ and a sustain period Sk₁ᵢ or Sk₂ᵢ of one sub-group G₁ᵢ or G₂ᵢ.

In the case that the length of the address period EAk₁ᵢ or EAk₂ᵢ of one of sub-groups G₁ᵢ and G₂ᵢ corresponds to the length of the sustain period Sk₁ᵢ or Sk₂ᵢ of the sub-groups G₁ᵢ and G₂ᵢ, a starting point of the respective subfields SF1 to SFL of the second row group G₂ is shifted by a time between a starting point of the respective subfields SF1 to SFL of the first row group G₁ and the address period EAk₁ᵢ or EAk₂ᵢ.

Accordingly, the row electrodes of the second row group G₂ can be applied with the sustain period during the address period of the row electrodes of the first row group G₁, and the row electrodes of the first row group G₁ can be applied with the sustain period during the address period of the row electrodes of the second row group G₂. That is, the sustain periods can be applied during the address periods rather that dividing the address period and the sustain period, thereby reducing the length of a subfield. In addition, prime particles formed during the sustain period can be efficiently used during the address period since the address period is provided between sustain periods of each sub-group such that a scan pulse width can be reduced, thereby achieving high-speed scan.

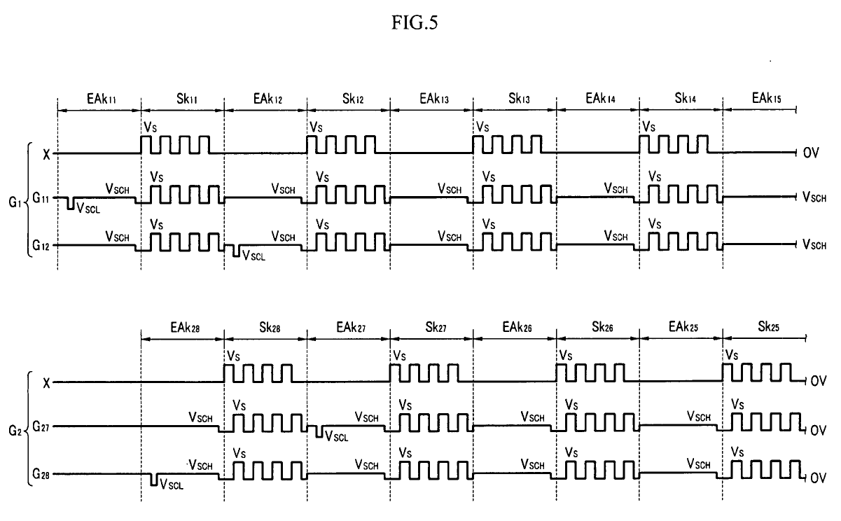

A driving waveform used for the driving method of the plasma display device is described in detail with reference to FIG. 5.

FIG. 5 shows a driving waveform of a plasma display device according to the driving method of FIG. 3. In FIG. 5, the first and second sub-groups G₁₁ and G₁₂ of the first row group G₁ and the seventh and eighth sub-groups G₂₇ and G₂₈ of the second row group G₂ are illustrated for the one subfield SFk.

As shown in FIG. 5, a scan pulse of a voltage V_{SCL} is sequentially applied to the plurality of Y electrodes of the first sub-group G₁₁ while a reference voltage (in FIG. 5, 0V) is applied to the X electrodes of the first sub-group G₁₁ during the address period EAk₁₁ of the first sub-group G₁₁. The address pulse (not shown) having a positive voltage is applied to the A electrodes of the cells to be selected as the non-light emitting cells from among the light emitting cells formed by the Y electrodes applied with the scan pulse. In addition, a voltage V_{SCH} that is greater than the voltage V_{SCL} is applied to the Y electrodes not applied with the scan pulse and the reference voltage is applied to the A electrodes not applied with the address pulse. As a result, the erase discharge is generated in the light emitting cells applied with the voltages V_{SCL} of the scan pulse and the positive voltage of the address pulse, and accordingly the wall charges formed on the X and Y electrodes are erased and set as the non-light emitting cells.

The sustain pulse having a high-level voltage (a voltage Vs in FIG. 5) and a low-level voltage (0V in FIG. 5) is applied in inverse phases to the plurality of X electrodes of the first row group G₁ and the Y electrodes of the first to eighth sub-groups G₁₁ to G₁₈, and accordingly the light emitting cells of the first sub-group G₁₁ are sustain-discharged. That is, the X electrode is applied with 0V while the Y electrode is applied with the voltage of Vs, and the Y electrode is applied with 0V while the X electrode is applied with the voltage of Vs. At this time, the cells having undergone no erase discharge during the address period EAk₁₁ among the light emitting cells of the immediately previous subfield SF(k−1) are in the light emitting cell state, and such a light emitting cell state is sustain-discharged.

Then, during the address period EAk₁₂ of the second sub-group G₁₂, the scan pulse of the voltage V_{SCL} is sequentially applied to the plurality of Y electrodes of the second sub-group G₁₂ while the reference voltage is applied to the X electrodes of the first row group G₁, and the address pulse (not shown) having a positive voltage is applied to the A electrodes of the cells to be selected as the non-light emitting cells among the light emitting cells formed by the Y electrodes applied with the scan pulse.

In addition, the sustain pulse is applied in inverse phases to the plurality of X electrodes of the first row group G₁ and the Y electrodes of the first to eighth sub-groups G₁₁ to G₁₈ during the sustain period Sk₁₂, and accordingly the light emitting cells are sustain-discharged. In such a manner, the address periods EAk₁₃ to EAk₁₈ and the sustain periods Sk₁₃ to Sk₁₈ are performed for other sub-groups G₁₃ to G₁₄.

Then, at the k-th subfield SFk of the first row group G₁, the address period EAk₂₈ of the second row group G₂ is performed while the sustain period Sk₁₁ of the first sub-group G₁₁ is performed. At the k-th subfield SFk of the second row group G₂, a scan pulse of a voltage V_{SCL} is sequentially applied to the plurality of Y electrodes of the eighth sub-group G₂₈ while the reference voltage is applied to the X electrodes of the second row group G₂, and the address pulse (not shown) having a positive voltage is applied to the A electrodes of the cells to be selected as the non-light emitting cells from among the light emitting cells formed by the Y electrodes applied with the scan pulse during address period EAk₂₈ of the eighth sub-group G₂₈.

In addition, the sustain pulse is applied in inverse phases to the plurality of X electrodes of the second row group G₂ and the Y electrodes of the first to eighth sub-groups G₂₁ to G₂₈ during the sustain period Sk₂₈, and accordingly the light emitting cells are sustain-discharged. At this time, the address period Eki₁₂ of the second sub-group G₁₂ is performed for the first row group G₁ while the sustain period S₂₈ is performed at the k-th subfield SFk of the second row group G₂. In such a manner, the address periods EAk₂₇ to EAk₂₁ and the sustain periods Sk₂₇ to Sk₂₁ are performed for other sub-groups G₂₇ to G₂₁.

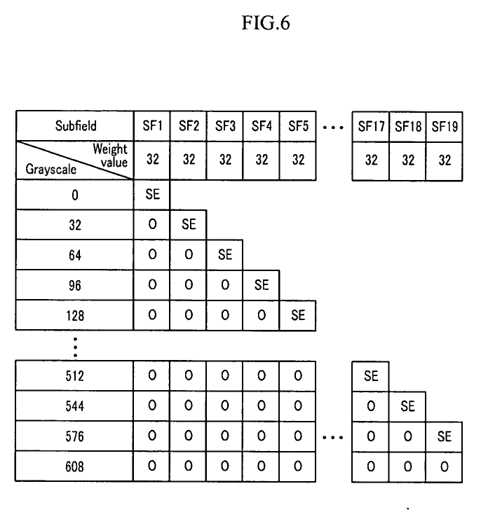

FIG. 6 shows a method for expressing a grayscale using a driving method of FIG. 3 according to an embodiment. In FIG. 6, one field includes the total number of 19 subfields, and the respective subfields have a weight value of 32. In addition, in FIG. 6, “SE” indicates the erase discharge that is generated in the corresponding subfield, and accordingly the light emitting cells are set as the non-light emitting cells, and “O” indicates the subfield of the light emitting cell state.

As shown in FIG. 6, when the erase discharge is generated during the address period of the first subfield SF1, and accordingly the cells become the non-light emitting cells, the sustain discharge is not generated during the sustain period and the sustain discharge is not generated even at the next subfields SF2 to SF19, and accordingly a grayscale of 0 is expressed. Next, when the erase discharge is generated during the address period of the second subfield SF2 and accordingly the cells become the non-light emitting cells, and the sustain discharge is not generated from the second subfield SF2 and accordingly a grayscale of 32 is expressed. When the erase discharge is not generated during the address period of the second subfield SF2, but is generated during the address period of the third subfield SF3 and accordingly the light emitting cells become the non-light emitting cell, a grayscale 64 may be expressed. That is, when the light emitting cells become the non-light emitting cells by the erase discharge of the K-th subfield, a grayscale of 32×(K−1) may be finally expressed because the sustain discharge is consecutively generated at the first to (K−1)-th subfields of the discharge cells of the light emitting cell state. That is, the grayscale corresponding to a multiple of 32 may be expressed among grayscales of 0 to 628 (=32×19). At this time, grayscales other than the multiple of 32 may be expressed using dithering. Such dithering is a technology for approximately and on average expressing the grayscale to be expressed in a predetermined area by combining predetermined grayscales. Therefore, a grayscale between the grayscales of 0 and 32 may be expressed using the grayscales of 0 and 32 in a predetermined pixel area.

In this embodiment all the cells are in the light emitting cells state at the first subfield SF1 until the address period of the corresponding sub-group is performed in the discharge cells of the sub-groups G₁₁ to G₁₈ and G₂₁ to G₂₈. Then, in the discharge cells of the i-th sub-group G₁ᵢ of the first row group G₁, the sustain discharges are generated during the total number of (i−1) unnecessary sustain periods S1₁₁ to S1₁₍ᵢ₋₁₎ until before the address period EA₁ᵢ is performed (here, i is an integer of 2 to 8). Therefore, in this embodiment, the i-th sub-group G₁ᵢ of the first row group G₁ may be set such that the sustain discharges are not generated during the sustain periods S1₁₁to S1₁₍ᵢ₋₁₎ of the first sub-group to the (i−1)-th sub-group (G₁₁ to G₁₍ᵢ₋₁₎) at the first subfield SF1. Likewise, the discharge cells of the (8−(i−1))-th sub-group G₂₍₈₋₍ᵢ₋₁₎₎ of the second row group G₂ may be set such that the sustain discharges are not generated during the eighth to the (8 to (i−2))-th sub-group G₂₈ to G₂₍₈₋₍ᵢ₋₂₎₎.

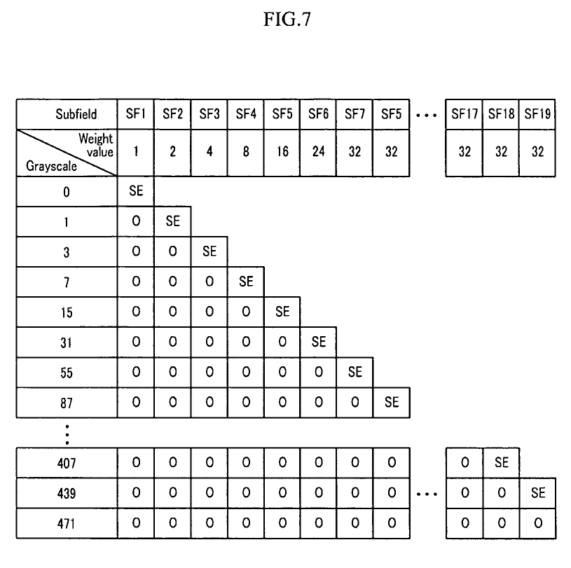

As such, a false contour may not be generated because the erase discharge is generated at the corresponding subfield of the plurality of subfields SF1 to SF19, so that the grayscale is expressed by the consecutive subfields before the discharge cells of the light emitting cell state become the non-light emitting cell. In addition, at most one discharge may be required to express any grayscale, because the discharge cells set as the light emitting cell state during the reset period R consecutively performs the erase discharge until they are set as the non-light emitting cells by the erase discharge at the respective subfields SF1 to SF19. Therefore, the power consumption according to the erase discharge may be reduced. However, the performance of low grayscale expression may be decreased in the case that the low grayscale is not expressed by the combination of the subfields, but it is expressed by the dithering. This is because the human eye may more effectively recognize a grayscale difference of a low grayscale than a grayscale difference of a high grayscale. A method for enhancing the performance of the low grayscale expression may be described with reference to FIG. 7.

FIG. 7 shows a method for expressing a grayscale using a driving method similar to that of FIG. 3 according to another embodiment.

As shown in FIG. 7, subfields SF1 to SFL are divided into first and second subfield groups. In addition, in order to enhance the performance of the low grayscale expression, weight values of subfields SF1, SF2, SF3, SF4, SF5, and SF6 of the first subfield group are respectively set as 1, 2, 4, 8, 16, and 24. At this time, grayscales 1, 3, 7, 15, 31, and 55 among the low grayscales expressed by dithering may be precisely expressed by the combination of the subfields SF1 to SF6 of the first subfield group. In addition, when the dithering is applied for these grayscales, the performance of the grayscale expression between the grayscales 1 to 55 may be enhanced.

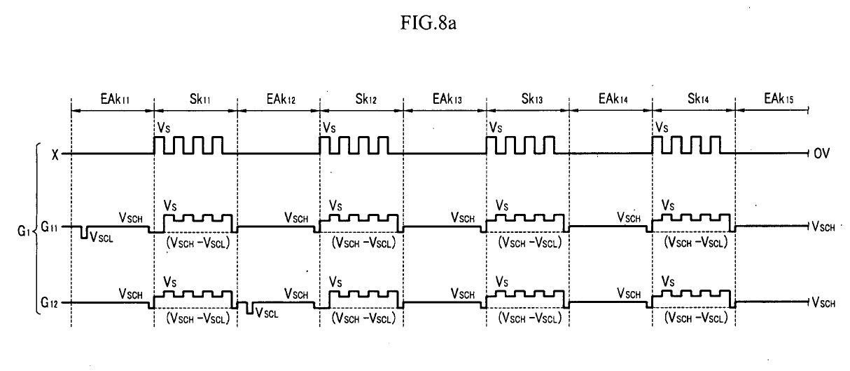

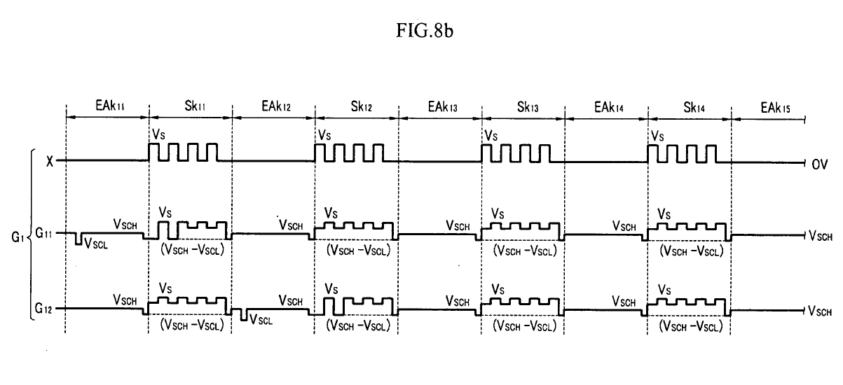

A method for realizing weight values of subfields SF1 to SF6 of the first group will be described with reference to FIG. 8A and FIG. 8B.

FIG. 8A and FIG. 8B respectively show a method for realizing a weight value of subfields SF1 to SF6. In FIG. 8A and FIG. 8B, the first and second sub-groups G₁₁ and G₁₂ of first row group G₁ are illustrated for better understanding and ease of description.

As described above, when the first and second row groups G₁ and G₂ are respectively divided into eight sub-groups G₁₁ to G₁₈ and G₂₁ to G₂₈, the weight values of the respective subfields SF1 to SFL correspond to the sum of the length of eight sustain periods at the respective subfields SF1 to SFL. For example, assuming that the weight value of the subfield SFk shown in FIG. 5 is given as 32, the length of the respective sustain periods Sk₁₁ to Sk₁₈ and Sk₂₁ to Sk₂₈ corresponds to the weight value 4 at the subfield SFk. In addition, it is assumed that four sustain pulses are applied to the respective X and Y electrodes during the respective sustain periods Sk₁₁ to Sk₁₈ and Sk₂₁ to Sk₂₈.

Therefore, the weight value 1 corresponds to ¼ of the length of any one sustain period Sk₁ⱼ among the sustain periods of the respective sub-groups G₁₁ to G₁₈ or G₂₁ to G₂₈ of any one row group G₁ or G₂ (wherein j is an integer of 1 to 8). Therefore, as shown in FIG. 8A, at the k-th subfield SFk of the first row group G₁, the voltage V_{SCH}-V_{SCL} corresponding to a difference between the voltages V_{SCH} and V_{SCL} is applied to the Y electrodes as the low level voltage of the sustain pulse while one sustain pulse is applied to the Y electrode of the first sub-group G₁₁ during the sustain period Sk₁₁ of the first sub-group G₁₁, and then the voltage Vs of the sustain pulse is applied to the X electrode. In addition, during other sustain periods Sk₁₂ to Sk₁₈ of the first sub-group G₁₁, the voltage V_{SCH}-V_{SCL} is applied to the Y electrode of the first sub-group G₁₁ as the low level voltage of the sustain pulse while the voltage Vs is applied to the X electrode. In addition, the voltage V_{SCH}-V_{SCL} is applied to the Y electrode as the low level voltage of the sustain pulse while one sustain pulse is applied to the Y electrode of the second sub-group G₁₂ during the sustain period Sk₁₂ of the second sub-group G₁₂, and then the voltage Vs of the sustain pulse is applied to the X electrode. In addition, during other sustain periods sustain periods Sk₁₃ to Sk₁₈ of the second sub-group G₁₂ and the sustain period S(K+1)₁₁ for the first sub-group G₁₁ of the (k+1)-th subfield SF(k+1), the voltage V_{SCH}-V_{SCL} is applied to the Y electrodes of the second sub-group G₁₂ as the low level voltage of the sustain pulse.

Since the subfield SF1 having a weight value of 1 is positioned during the reset period R as described above, the respective sub-groups G₁ᵢ or G₂₍₈₋₍ᵢ₋₁₎₎ are set such that the sustain discharges are not generated during the sustain periods S₁₁ to S₁₍ᵢ₋₁₎ or G₂₈ to G₂₍₈₋₍ᵢ₋₂₎₎ before the corresponding address periods EA₁ᵢ or EA₂₍₈₋₍ᵢ₋₁₎₎. Therefore, the voltage V_{SCH}-V_{SCL} may be applied to the Y electrodes of the respective sub-groups G₁ᵢ or G₂₍₈₋₍ᵢ₋₁₎₎ as the low level voltage of the sustain pulse during the sustain periods S₁₁ to S₁₍ᵢ₋₁₎ or G₂₈ to G₂₍₈₋₍ᵢ₋₂₎₎ before the corresponding address periods EA₁ᵢ or EA₂₍₈₋₍ᵢ₋₁₎₎. That is, as shown in FIG. 8A, the voltage V_{SCH}-V_{SCL} may be applied to the Y electrodes of the second sub-group G₁₂ as the low level voltage of the sustain pulse during the sustain period S₁₁ before the address period EA₁₂ of the second sub-group G₁₂.

Here, the difference Vs−(VscH-VscL) between the voltage Vs and the voltage VscH-VscL is determined such that the sustain discharge may not be generated between the electrodes X and Y. Then, the sustain discharge is not generated between the electrodes X and Y when the voltage VscH to VscL may be applied to the Y electrode. If the sustain discharge is not generated between the X and Y electrodes when the voltage Vs is applied to the X electrode, a wall potential of the X electrodes is maintained greater than that of the Y electrodes, and accordingly the sustain discharge is not generated again even when the voltage Vs is applied to the electrode Y and 0V is applied to the X electrode. In such a manner, the subfield having the weight value of 1 may be realized.

In addition, a driving method of the second row group G₂ is substantially the same as the driving method of the first row group G₁ except that the voltage V_{SCH}-V_{SCL} may be applied to the Y electrode of the eighth sub-groups G₈ as the low level voltage of the sustain pulse when one single sustain pulse is applied to the Y electrode of the eighth sub-group G₂₈ and then the voltage Vs of the sustain pulse is applied to the X electrode during the sustain period Sk₂₈ of the second row group G₂.

In addition, the voltage V_{SCH}-V_{SCL} may be applied to the Y electrodes of other sustain periods Sk₂₇ to Sk₂₁ of the second row group G₂ as the low level voltage of the sustain pulse when the sustain pulse is applied to the X electrode. The sustain discharge may be controlled in the light-emitting cells of other sub-groups from the seventh sub-group G₂₇ to the first sub-group G₂₁. In this embodiment, the weight value may be described for the first sub-group G₁₁ of the first row group G₁.

The weight value 2 corresponds to half of the length of any one sustain period Sk₁ⱼ of the respective sub-groups G₁₁ to G₁₈ or G₂₁ to G₂₈ of one row group G₁ or G₂. Accordingly, as shown in FIG. 8B, at the k-th subfield SFk of the first row group G₁, the voltage V_{SCH}-V_{SCL} is applied to the Y electrode as the low level voltage of the sustain pulse when two sustain pulses are applied to the Y electrode of the first sub-group G₁₁ and then the voltage Vs of the sustain pulse is applied to the X electrode during the sustain period Sk₁₁ of the first sub-group G₁₁. In addition, the voltage V_{SCH}-V_{SCL} is applied to the Y electrode as the low level voltage of the sustain pulse when the voltage Vs of the sustain pulse is applied to the X electrode even during other sustain periods Sk₁₂ to Sk₁₈ of the first sub-group G₁₁. The voltage V_{SCH}-V_{SCL} is applied to the Y electrode of the second sub-group G₁₂ as the low level voltage of the sustain pulse when two sustain pulses are applied to the Y electrode and then the voltage Vs of the sustain pulse is applied to the X electrode during the sustain period Sk₁₂ of the second sub-group G₁₂. Further, the voltage V_{SCH}-V_{SCL} is applied to the Y electrode of second sub-group G₁₂ as the low level voltage of the sustain pulse during the sustain period S(K+1)₁₁ of the first sub-group G₁₁ of (k+1)-th subfield SF(k+1) as well as other sustain periods Sk₁₃ to Sk₁₈ of the second sub-group G₁₂. The voltage V_{SCH}-V_{SCL} may be applied to the Y electrode of the second sub-group G₁₂ as the low level voltage of the sustain pulse during the sustain period S₁₁ before the address period EA₁₂ of the second sub-group G₁₂. In such a manner, the subfield having the weight value 2 may be realized.

At the k-th subfield SFk of the first row group G₁, the voltage V_{SCH}-V_{SCL} is applied to the Y electrode as the low level voltage of the sustain pulse when four sustain pulses are applied to the Y electrode of the first sub-group G₁₁ and then the voltage Vs of the sustain pulse is applied to the X electrode during the sustain period Sk₁₂ to Sk₁₈ of the first sub-group G₁₁, and thus the subfield having the weight value 4 may be realized. Then, at the k-th subfield SFk of the first row group G₁, the voltage V_{SCH}-V_{SCL} is applied to the Y electrode as the low level voltage of the sustain pulse when four sustain pulses are applied to the Y electrode of the first sub-group G₁₁ during the sustain period Sk₁₁ and Sk₁₂ of the first sub-group G₁₁ and then the voltage Vs of the sustain pulse is applied to the X electrode during other sustain periods Sk₁₃ to Sk₁₈ of the first sub-group G₁₁, and thus the subfield having the weight value of 8 may be realized.

In addition, assuming that the subfield SFk shown in FIG. 5 has the weight value of 32, the sustain discharges are generated in all the sub-groups G₁₁ to G₁₈ of the first row group G₁ when the address period of the first sub-group G₂₁ is performed for the second row group G₂. A weight value of 24 may be realized by the subfield in which the sustain discharges are generated in only six sub-groups G₁₁ to G₁₆ among the sub-groups G₁₁ to G₁₈ of the first row group G₁ when the address period of the first sub-group G₂₁ is performed for the second row group G₂, and a weight value of 16 may be realized by the subfield which the sustain discharges are generated in only four sub-groups G₁₁ to G₁₄ among the sub-groups G₁₁ to G₁₈ of the first row group G₁ when the address period of the first sub-group G₂₁ is performed for the second row group G₂. A weight value of 8 may be realized by the subfield in which the sustain discharges are generated in only two sub-groups G₁₁ and G₁₂ among the sub-groups G₁₁ to G₁₈ of the first row group G₁, and a weight value of 4 may be realized by the subfield in which the sustain discharges are generated in only one sub-group G₁₁ among the sub-groups G₁₁ to G₁₈ of the first row group G₁. Weight values of less than 4 may be realized by the subfield in which the sustain discharges are generated in only a part of one sub-group G₁₁ among the sub-groups G₁₁ to G₁₈ of the first row group G₁.

It is but one example that the Y electrode is applied with the voltage V_{SCH}-V_{SCL} as the low level voltage such that the sustain discharge is not generated between the electrodes X and Y in FIG. 8A and FIG. 8B. Accordingly, the Y electrode may be floated such that the sustain discharge is not generated between the electrodes X and Y. When the Y electrode is floated, the voltage of the Y electrodes is changed depending on the voltage of the X electrode, and accordingly the difference between the X and Y electrodes is reduced and thus the light emitting cells are not sustain-discharged. One of the X and Y electrodes may be applied consecutively with the high level voltage Vs or a low level voltage 0V.

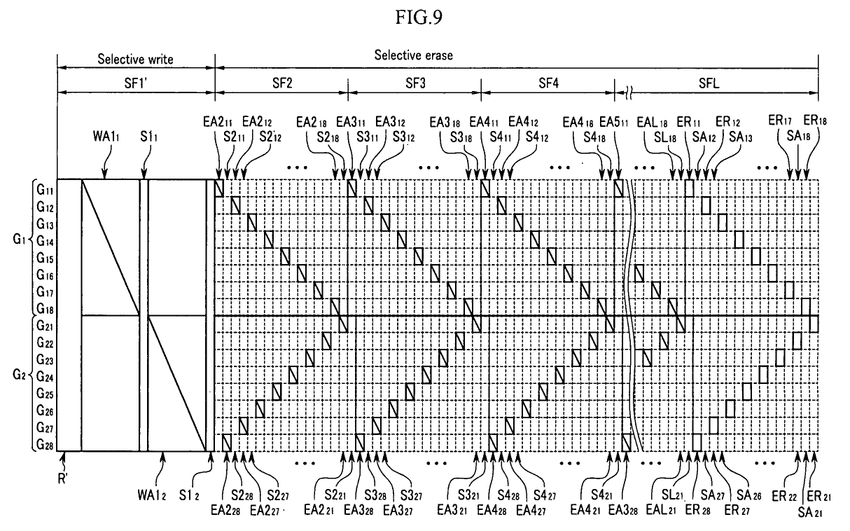

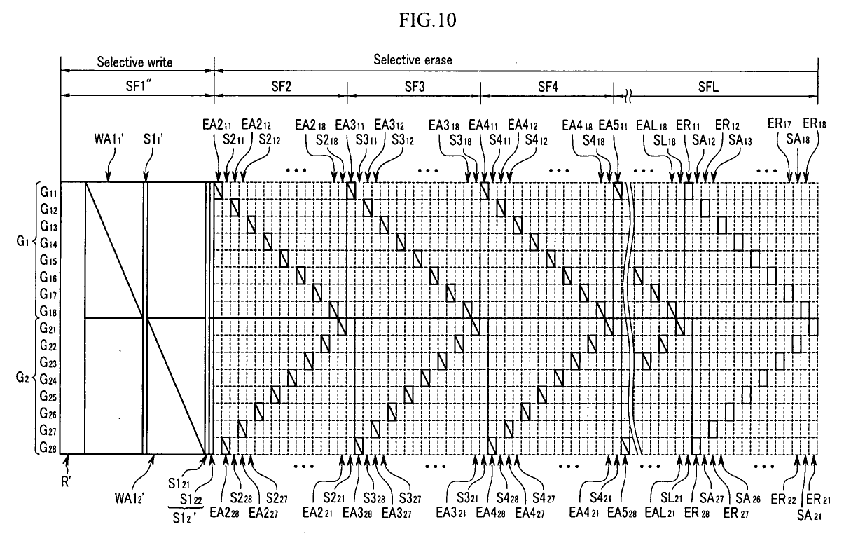

According to the driving method some embodiments, the reset discharge must become a strong discharge in order for all the discharge cells to be initialized during the reset period R before the address period of the first subfield SF1 and thus the discharge cells are set into the light emitting cell state. In this case, the contrast ratio may be decreased because the black screen looks bright. In addition, it is difficult for the wall charges to be sufficiently generated during only the reset period R such that all the discharge cells are set as the light emitting cells. A method for stably generating an erase discharge that is capable of enhancing the contrast ratio will be described in detail with reference to FIG. 9 and FIG. 10.

FIGS. 9 and 10 show driving methods of a plasma display device.

As shown in FIG. 9, the selective write method is used during address periods WA1₁ and WA1₂ of a first subfield SF1′. In addition, at the first subfield SF1′, the respective groups G₁ and G₂ of the plurality of row electrodes are not grouped into the sub-groups and the light emitting cells are selected from among the discharge cells formed by the plurality of row electrodes during one of the address period WA1₁ and WA1₂. As such, at the subfield SF1′ having the address period WA1₁ or WA1₂ of the selective write method, a reset period R′ is performed and is for initializing the light emitting cells into the non-light emitting cells before the address period WA1₁ or WA1₂. That is, the light emitting cells are initialized into the non-light emitting cells at the reset period R′ before the address period WA1₁ or WA1₂, unlike the charge cells being initialized into the light emitting cell state in the reset period R before the address periods EA1₁₁ to EAL₁₈ and EA1₂₁ to EAL₂₈ of the selective erase method described above.

In more detail, at the reset period R′ of the first subfield SF1′, the discharge cells of the first and second row groups G₁ and G₂ are initialized and set as the non-light emitting cell state such that the write discharge may be generated during the address period WA1₁ and WA1₂. During the address period WA1₁, the write discharge is generated in the discharge cells to be set as the light emitting cells among the discharge cells of the first row group G₁, and accordingly the wall charges are generated. Then, during the sustain period S1₁, the light emitting cells of the first row group G₁ are sustain-discharged. Then, the wall charges formed on the light emitting cells of the first row group G₁ are erased. The light is emitted only during the sustain period S1₁ of the first sub-group G₁₁ among the light emitting cells of the first row group G₁.

Next, during the address period WA1₂, the write discharge is generated in the discharge cells to be set as the light emitting cells among the discharge cells of the second row group G₂, and accordingly the wall charges are generated. Then, during the sustain period S1₂ the light emitting cells of the second row group G₂ are sustain-discharged, and accordingly the wall charges are erased.

As such, the write discharge is sequentially performed for the plurality of row electrodes of the first and second row groups G₁ and G₂ during the address period WA1₁ and WA1₂, and thus the light emitting cells are selected and then sustain-discharged during the sustain periods S1₁ and S1₂. In such a manner, the wall charges may be sufficiently formed on the respective electrodes of the light emitting cells before the subfields SF2 to SFL having the address period of the selective erase method are performed.

Meanwhile, in order for the wall charges formed in the light emitting cells of the respective groups G₁ and G₂ after the sustain periods S1₁ and S1₂ of the respective groups G₁ and G₂ to be erased at the first subfield SF1′, the pulse width of the last sustain pulse is set to be narrower than that of other sustain pulses during the sustain periods S1₁ and S1₂ of the respective groups G₁ and G₂ such that the wall charges are not formed. In addition, the wall charges formed by the sustain discharges may be erased using a waveform in which a voltage of the row electrodes is gradually changed immediately after the last sustain discharge pulse (e.g., a waveform changed in a ramp pattern).

In order for the light emitting cells to be initialized into the non-light emitting cells at the reset period R′ immediately before the address period WA1₁ or WA1₂ of the selective write method, a voltage may be gradually increased or gradually reduced at the reset period. That is, it may be realized by the voltage of the plurality of Y electrodes being gradually increased and then gradually reduced during the reset period R′. In other words, the light emitting cells are initialized by erasing the wall charges on the discharge cells when a weak reset discharge is generated between the X and Y electrodes while the voltage of the plurality of Y electrodes is gradually increased and then gradually reduced. Accordingly, the strong discharge is not generated during the reset period RI, thereby enhancing the contrast ratio.

Like the embodiment shown in FIG. 9, the operation for erasing the wall charges formed in the light emitting cells of the respective groups G₁ and G₂ after the sustain periods S1₁ and S1₂ of the respective groups G₁ and G₂ may not be operated.

In more detail, as shown in FIG. 10, during the address period WA1₁′ of the first subfield SF″ the write discharge is generated in the discharge cells to be set as the light emitting cells among the discharge cells of the first row group G₁, and accordingly the wall charges are formed thereon. Then, during the sustain period S1₁′, the light emitting cells are sustain-discharged. At this time, it is set such that the minimum number of sustain discharges, for example one or two sustain discharges, are generated during the sustain period S1₁′.

Next, during the address period WA1₂′ of the first subfield SF1′, the write discharge is generated in the discharge cells to be set as the light emitting cells among the discharge cells of the second row group G₂, and accordingly the wall charges are generated. Then, during a partial period S1₂₁ (not shown) of the sustain period S1₂, the light emitting cells of the first and second row groups G₁ and G₂ are sustain-discharged. In addition, during another partial period S1₂₂ (not shown) of the sustain period S1₂, the light emitting cells of the first row group G₁ are not sustain-discharged but the light emitting cells of the second row group G₂ are sustain-discharged. Accordingly, the same number of sustain discharges is set to be generated in the light emitting cells of the second row group G₂ during the other partial period S1₂₂ of the sustain period S1₂ and in the light emitting cells of the first row group G₁ during the sustain period S1₂.

In addition, when the weight value of first subfield SF1′ is not expressed by the two sustain periods S1₁′ and S1₂′, the light emitting cells of the first and second row groups G₁ and G₂ may be additionally sustain-discharged during the other partial period S1₂₂ of the sustain period S1₂.

In addition, according to the some embodiments, at the last subfield SFL of one field, the erase periods ER1₁₂ to ER1₁₈ and ER1₂₂ to ER1₂₈ and the additional sustain periods SA₁₂ to SA₁₈ and SA₂₂ to SA₂₈ of the first and the second row groups G₁ and G₂ may or may not be performed. When the erase periods ER1₁₂ to ER1₁₈ and ER1₂₂ to ER1₂₈ and the additional sustain periods SA₁₂ to SA₁₈ and SA₂₂ to SA₂₈ are not performed, the addressing orders of the respective sub-groups G₁₁ to G₁₈ and G₂₁ to G₂₈ among the respective groups G₁ and G₂ over the plurality of fields are changed. Consequently, the respective row groups may be sustain-discharged by the same times.

In addition, in some embodiments, it is set that the sustain discharge is not generated after the erase periods ER1₁₂ to ER1₁₈ and ER1₂₂ to ER1₂₈ of the first and second row groups G₁ and G₂ are performed, such that the respective row groups may be sustain-discharged for substantially the same amount of time. That is, as shown in FIG. 8A and FIG. 8B, after the erase periods ER1₁₂ to ER1₁₈ and ER1₂₂ to ER1₂₈ of the first and second row groups G₁ and G₂ are performed, the voltages V_{SCH} to V_{SCL} are applied to the Y electrodes when the voltage Vs of the sustain pulse is applied to the electrode X, and the voltage Vs is applied to the Y electrodes when 0V is applied to the X electrodes. The sustain discharge is not generated after the erase periods ER1₁₂ to ER1₁₈ and ER1₂₂ to ER1₂₈ of the first and second row groups G₁ and G₂ are performed.

If, for example, 1024 row electrodes are driven under conditions that the selective erase method uses a width of the scan pulse of 0.7 μs, the eight sustain pulses are input during one sustain period, one sustain pulse (the pulse having high and low level voltages) is input for 5.6 μs, the length of the sustain period is given as 44.8 μs (=5.6 μs×8 rows), and the length of the address period is given as 44.8 μs (=0.7 μs×64 rows). Therefore, the length of the subfield is given as 716.8 μs (=44.8 μs×16). In addition, when the selective write method uses a width of a scan pulse of 1.3 μs and a length of the reset period is given as 350 μs, the length of the address period is given as 665.6 μs (=1.3 μs×512 rows). In the case of the weight value of 1, assuming that 1 sustain pulse is applied during the sustain period S1₁ and 1.5 sustain pulses are applied during the sustain period S1₂, the length of the total of the sustain period S1₁+S1₂ is given as 14 μs (=5.6 μs×2.5). Therefore, the length of the subfield SF1 is given as 1695.2 μs (=350 μs+665.6 μs×2+14 μs).

Thus, since time allocated to the subfield of the selective erase method is given as 14970.8 μs (=16666 to 1695.2) at one field, the 20 (=14970.8/716.8) subfields of the selective erase method may be used at one field.

In addition, it is but one example that the sustain pulse alternately having the voltage Vs and 0V in FIG. 5 is applied to the X and Y electrodes in inverse phases. Accordingly, sustain pulses of other shapes may also be applied. For example, the voltages-Vs and Vs may be applied to the Y electrodes while the X electrodes are biased as 0V.

As described above, according to the embodiments, the plurality of row electrodes may be divided into the first and second row groups and the respective groups may again be divided into the plurality of sub-groups. In addition, at the respective subfields of the one field, the address periods may be performed in the respective sub-groups of the first and second row groups, the sustain periods may be performed between the address periods of the respective sub-groups. In addition, the address periods may be performed in the respective sub-groups of the second row group while the sustain periods are performed in the respective sub-groups of the first row group, and the address periods may performed in the respective sub-groups of the first row group while the sustain periods are performed in the respective sub-groups of the second row group. As such, since the priming particles formed during the sustain period are sufficiently used during the address period in which the address periods is disposed between the sustain periods of the respective sub-groups, the width of the scan pulse become shorter thereby increasing the speed of the scan, and the sustain period may be operated during the address period thereby reducing the length of the subfield.

The address periods of the respective subfield are driven by the selective erase method, and the grayscales are expressed by the consecutive subfields until before the erase discharge is generated at the corresponding-subfield, and thus the false contour may not be generated. Since only one erase discharge is generated for expressing any grayscales, the power consumption may be reduced.

When the first address period of the respective subfields is driven by the selective write method, sufficient wall charges may be formed, and accordingly erase discharge may be stably generated at the next subfields driven by the selective erase method. The voltage that is gradually increased or gradually reduced is applied during the reset period of the subfield of the selective write method, and accordingly the strong discharge is not generated during the reset period, thereby enhancing the contrast ratio.

While this invention has been described in connection with what is presently considered to be practical embodiments, it is to be understood that the invention is not limited to the disclosed embodiments.

What is claimed is:

1. A method of driving a plasma display device, the plasma display device having a plurality of row electrodes, a plurality of column electrodes, and a plurality of discharge cells, the method comprising:
dividing a frame into subfields;
dividing the plurality of row electrodes into first and second row groups;
dividing the first row group into a plurality of first sub-groups;
dividing the second row group into a plurality of second sub-groups;
selecting one or more discharge cells from a first sub-group to be non-light emitting during a first period of a first subfield, wherein the remaining discharge cells of the first sub-group remain light emitting;
sustain-discharging one or more light emitting cells of a second sub-group during the first period;
selecting one or more discharge cells from a second sub-group to be non-light emitting during a second period of a first subfield, wherein the remaining discharge cells of the second sub-group remain light emitting; and
sustain-discharging one or more light emitting cells of a first sub-group during the second period.

2. The method of claim 1, further comprising:
selecting one or more discharge cells from another first sub-group to be non-light emitting during a third period of the first subfield, wherein the remaining discharge cells of the other first sub-group remain light emitting;
sustain-discharging one or more light emitting cells of a second sub-group during the third period;
selecting one or more discharge cells from another second sub-group to be non-light emitting during a fourth period of the first subfield, wherein the remaining discharge cells of the other second sub-group remain light emitting; and
sustain-discharging one or more light emitting cells of a first sub-group during the fourth period.

3. The method of claim 2, further comprising initializing the plurality of discharge cells as light emitting cells before selecting the non-light emitting cells.

4. The method of claim 2, further comprising:
during a second subfield, selecting light emitting cells from the first row group of discharge cells and sustain-discharging the selected light emitting cells of the first row group; and
during the second subfield, selecting light emitting cells from the second row group of discharge cells and sustain discharging the selected light emitting cells of the second row group.

5. The driving method of claim 4, further comprising, at the second subfield, initializing the plurality of discharge cells as non-light emitting cells before selecting the light emitting cells among the first row group of discharge cells.

6. The method of claim 5, wherein at the second subfield, the first row group of light emitting cells remain un-sustain-discharged during a first part of a period wherein the second row group of light emitting cells are sustain-discharged.

7. The driving method of claim 6, wherein, at the second subfield, the first row group of light emitting cells are sustain-discharged during a remaining part of the period wherein the second row group of light emitting cells are sustain-discharged.

8. The driving method of claim 1, wherein:
the light emitting cells of the second group remain un-sustain-discharged during a part of the first period; and
the light emitting cells of the first group remain un-sustain-discharged during a part of the second period.

9. The method of claim 1, wherein another second sub-group remains un-sustain-discharged during the second period.

10. The method of claim 1, wherein:
the plurality of row electrodes include a plurality of first electrodes and a plurality of second electrodes, and the first and second electrodes are configured to perform a display operation;
sustain-discharging the one or more light emitting cells of the second sub-group comprises applying first and second sustain pulses to the plurality of first and second electrodes of the second sub-group;
sustain-discharging the one or more light emitting cells of the first sub-group comprises applying first and second sustain pulses to the plurality of first and second electrodes of the first sub-group; and
the first and second sustain pulses have high and low level voltages in opposite phases.

11. The method of claim 1, wherein the plurality of row electrodes include a plurality of first electrodes and a plurality of second electrodes, and the first and second electrodes are configured to perform a display operation, the method further comprising:
sustain-discharging the one or more light emitting cells of the second sub-group comprises applying at least one sustain pulse alternately having high and low level voltages to the plurality of second electrodes while a first voltage is applied to the plurality of first electrodes of the plurality of second sub-groups; and
sustain-discharging the one or more light emitting cells of the first sub-group comprises applying at least one sustain pulse alternately having high and low level voltages to the plurality of second electrodes while the first voltage is applied to the plurality of first electrodes of the plurality of second sub-groups.

12. The method of claim 1, wherein some subfields have a weight value differing from the weight value of one or more other subfields.

13. The method of claim 1, wherein
the first row group includes row electrodes disposed on the upper area of the plasma display device, and
the second row group includes row electrodes disposed on the lower area of the plasma display device.

14. A plasma display device comprising:
a plasma display panel (PDP) including:
a plurality of row electrodes configured to perform a display operation and a plurality of column electrodes formed in a direction crossing the row electrodes; and
a plurality of cells formed near crossing points of the plurality of row electrodes and the plurality of column electrodes;
a controller configured to:
divide a field into a plurality of subfields;
divide the plurality of row electrodes into first and second row groups;
divide the first row group of row electrodes into a plurality of first sub-groups; and
divide the second row group of row electrodes into a plurality of second sub-groups; and
a driver configured to drive the plurality of row electrodes and the plurality of column electrodes,
wherein the driver is configured to:
select one or more discharge cells from a first sub-group to be non-light emitting during a first period of a first subfield, wherein the remaining discharge cells of the first sub-group remain light emitting;
sustain-discharge one or more light emitting cells of a second sub-group during the first period;
select one or more discharge cells from a second sub-group to be non-light emitting during a second period of a first subfield, wherein the remaining discharge cells of the second sub-group remain light emitting; and
sustain-discharge one or more light emitting cells of a first sub-group during the second period.

15. The device of claim 14, wherein the driver is further configured to:
during a second subfield, select light emitting cells from the first row group of discharge cells and sustain-discharge the selected light emitting cells of the first row group; and
during the second subfield, select light emitting cells from the second row group of discharge cells and sustain discharge the selected light emitting cells of the second row group.

16. The device of claim 14, wherein the driver is further configured to during the second subfield, initialize the plurality of discharge cells as non-light emitting cells before selecting the light emitting cells among the first row group of discharge cells.

17. A method of driving a plasma display device, the plasma display device having a plurality of row electrodes, a plurality of column electrodes, and a plurality of discharge cells, the method comprising:
dividing a frame into a plurality of subfields
dividing the plurality of row electrodes into first and second row groups;
dividing the first row group into a plurality of first sub-groups and dividing the second row group into a plurality of second sub-groups;
during a first subfield, selecting light emitting cells from the first row group and sustain discharging the selected light emitting cells of the first row group;
during the first subfield, selecting light emitting cells from the second row group and sustain-discharging the selected light emitting cells of the second row group;
selecting non-light emitting cells from a first sub-group and sustain-discharging light emitting cells of a second sub-group during a first period of a second subfield; and
selecting non-light emitting cells from a second sub-group and sustain-discharging the light emitting cells of a first sub-group during a second period during the second subfield.

18. The method of claim 17, further comprising:
selecting non-light emitting cells from another first sub-group and sustain-discharging light emitting cells of the second sub-group during a third period of the second subfield ; and
selecting non-light emitting cells from another second sub-group and sustain-discharging light emitting cells of at least one first sub-group during a fourth period of the second subfield.

19. The method of claim 18, further comprising, during the first subfield, initializing the plurality of discharge cells as non-light emitting cells before selecting the light emitting cells.

20. The method of claim 19, wherein the plurality of row electrodes include a plurality of first electrodes and a plurality of second electrodes, and the first and second electrodes are configured to perform a display operation, and wherein initializing the plurality of discharge cells as non-light emitting cells includes gradually increasing a voltage difference between the first and second electrodes and gradually reducing a voltage difference between the first and second electrodes.
